(19) United States
(12) Patent Application Publication
(10) Pub. No.: US 2019/0312459 A1
(43) Pub. Date: Oct. 10, 2019

(54) Wireless Power System With Low Power Mode Switching

(71) Applicant: Apple Inc., Cupertino, CA (US)

(72) Inventors: Brandon R. Garbus, Santa Clara, CA (US); Daniel Huber, Auckland (NZ); Jason P. Marini, Morgan Hill, CA (US); Stephen C. Terry, San Jose, CA (US); YiBo Liu, Cupertino, CA (US)

(21) Appl. No.: 16/051,350

(22) Filed: Jul. 31, 2018

Related U.S. Application Data
(60) Provisional application No. 62/653,276, filed on Apr. 5, 2018.

(51) Int. Cl. H02J 50/10; H02J 7/02; G06F 3/0354

(52) U.S. Cl. CPC H02J 50/10; G06F 3/03545; H02J 7/025

(57) ABSTRACT

A wireless power system has a wireless power transmitting device that uses an inverter to apply alternating-current signals to a coil. In response, the coil generates wireless power signals that are received by a coil in a wireless power receiving circuit of a wireless power receiving device. While wireless power is being transferred to the receiving device, the receiving device communicates with the wireless power transmitting device using in-band communications. The wireless power receiving device can issue a halt-wireless-power-transmission command using in-band communications to direct the wireless power transmitting device to stop transmitting wireless power. When power is not being transferred, the wireless power transmitting device transmits a series of short impulses that are monitored by the receiving device. The receiving device can direct the transmitting device to resume power transmission by adjusting an adjustable impedance circuit coupled to the wireless power receiving circuit.

This application claims the benefit of provisional patent application No. 62/653,276, filed Apr. 5, 2018, which is hereby incorporated by reference herein in its entirety.

### FIELD

This relates generally to power systems, and, more particularly, to wireless power systems for charging electronic devices.

### BACKGROUND

In a wireless charging system, a wireless power transmitting device wirelessly transmits power to a wireless power receiving device that is placed on the wireless power transmitting device. The receiving device has a coil and rectifier circuitry. The coil receives alternating-current wireless power signals from a coil in the transmitting device that is overlapped by the coil in the receiving device. The rectifier circuitry converts the received signals into direct-current power.

### SUMMARY

A wireless power system has a wireless power transmitting device that uses an inverter to supply alternating-current signals to a coil and thereby transmit wireless power signals to a wireless power receiving circuit of a wireless power receiving device.

The system operates in an active wireless power transfer mode in which power is transmitted wirelessly between the transmitting device and the receiving device. The system also operates in a wireless-power-transfer-halted mode in which the transmitting device does not transmit power.

During the active wireless power transfer mode, while wireless power is being transferred to the receiving device, the receiving device communicates with the wireless power transmitting device using in-band communications. When the wireless power receiving device no longer desires to receive wireless power, the wireless power receiving device sends an in-band halt-wireless-power-transfer command. This command directs the wireless power transmitting device to stop transmitting wireless power and places the system in the wireless-power-transfer-halted mode.

In the wireless-power-transfer-halted mode, when power is not being transferred, the wireless power transmitting device transmits a series of short impulses that are monitored by the receiving device. This informs the receiving device that the transmitting device is present. Analysis of an associated impulse response at the transmitting device provides the transmitting device with information on the impedance of the coil of the transmitting device. When power is desired, the receiving device directs the transmitting device to resume power transmission by adjusting an adjustable impedance circuit coupled to the wireless power receiving circuit. The adjustable impedance circuit produces a mode-switching impedance change in the wireless power receiving circuit of the receiver and in the coil of the transmitting device. The transmitting device detects the impedance change and halts power transmission.

### BRIEF DESCRIPTION OF THE DRAWINGS

FIG. 1 is a schematic diagram of an illustrative wireless charging system that includes a wireless power transmitting device and a wireless power receiving device in accordance with an embodiment.

FIG. 2 is a graph of an illustrative impulse response signal measured in a wireless power transmitting circuit of a wireless power transmitting device in accordance with an embodiment.

FIG. 3 is a circuit diagram of an illustrative wireless power transmitting circuit and wireless power receiving circuit in accordance with an embodiment.

FIG. 4 is a graph showing measurements of impedance versus time made by a wireless power transmitting device in accordance with an embodiment.

FIG. 5 is a flow chart of illustrative operations involved in using a wireless power transmission system in accordance with an embodiment.

### DETAILED DESCRIPTION

A wireless power system includes a wireless power transmitting device. The wireless power transmitting device wirelessly transmits power to one or more wireless power receiving devices. The wireless power receiving devices may include electronic devices such as wristwatches, cellular telephones, tablet computers, laptop computers, ear buds, battery cases for ear buds and other devices, tablet computer styluses (pencils) and other input-output devices, wearable devices, or other electronic equipment. The wireless power transmitting device may be an electronic device such as a wireless charging mat, a tablet computer or other portable electronic device with wireless power transmitting circuitry, or other wireless power transmitting device. The wireless power receiving devices use power from the wireless power transmitting device for powering internal components and for charging an internal battery. Because transmitted wireless power is often used for charging internal batteries, wireless power transmission operations are sometimes referred to as wireless charging operations.

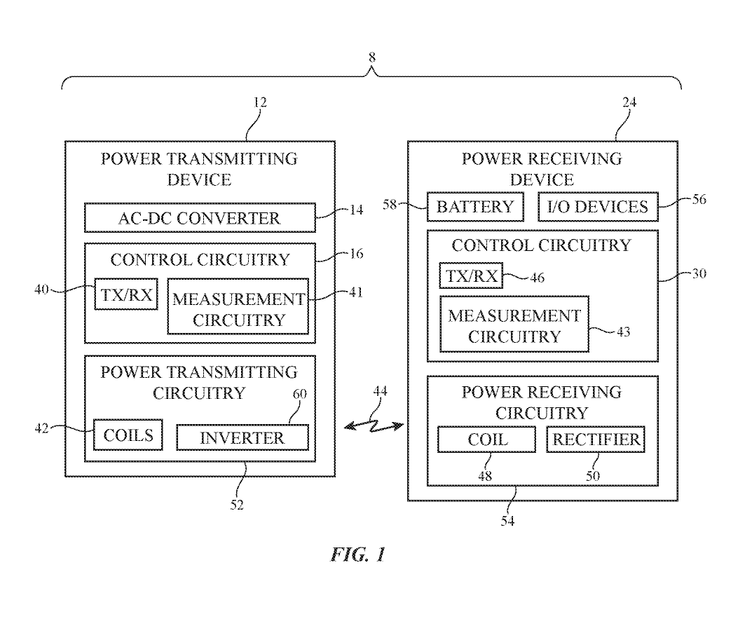

An illustrative wireless power system (wireless charging system) is shown in FIG. 1. As shown in FIG. 1, wireless power system 8 includes a wireless power transmitting device such as wireless power transmitting device 12 and includes a wireless power receiving device such as wireless power receiving device 24. Wireless power transmitting device 12 includes control circuitry 16. Wireless power receiving device 24 includes control circuitry 30. Control circuitry in system 8 such as control circuitry 16 and control circuitry 30 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 12 and 24. For example, the processing circuitry may be used in selecting coils, determining power transmission levels, processing sensor data and other data, processing user input, handling negotiations between devices 12 and 24, sending and receiving in-band and out-of-band data, making measurements, and otherwise controlling the operation of system 8.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may be a stand-alone power adapter (e.g., a wireless charging mat that includes power adapter circuitry), may be a wireless charging mat that is coupled to a power adapter or other equipment by a cable, may be a portable electronic device (cellular telephone, tablet computer, laptop computer, etc.), may be equipment that has been incorporated into furniture, a vehicle, or other system, or may be other wireless power transfer equipment. Illustrative configurations in which wireless power transmitting device 12 is a wireless charging mat or portable electronic device are sometimes described herein as an example.

Power receiving device 24 may be a portable electronic device such as a wristwatch, a cellular telephone, a laptop computer, a tablet computer, an accessory such as an earbud, a tablet computer input device such as a wireless tablet computer stylus (pencil), a battery case, or other electronic equipment. Power transmitting device 12 may be coupled to a wall outlet (e.g., an alternating current power source), may have a battery for supplying power, and/or may have another source of power. Power transmitting device 12 may have an alternating-current (AC) to direct-current (DC) power converter such as AC-DC power converter 14 for converting AC power from a wall outlet or other power source into DC power. In some configurations, AC-DC power converter 14 may be provided in an enclosure (e.g., a power brick enclosure) that is separate from the enclosure of device 12 (e.g., a wireless charging mat enclosure or portable electronic device enclosure) and a cable may be used to couple DC power from the power converter to device 12. DC power may be used to power control circuitry 16. During operation, a controller in control circuitry 16 may use power transmitting circuitry 52 to transmit wireless power to power receiving circuitry 54 of device 24. Power transmitting circuitry 52 may have switching circuitry (e.g., inverter circuitry 60 formed from transistors) that is turned on and off based on control signals provided by control circuitry 16 to create AC current signals through one or more transmit coils 42. Coils 42 may be arranged in a planar coil array (e.g., in configurations in which device 12 is a wireless charging mat) or may be arranged in other configurations. In some arrangements, device 12 may have only a single coil. In arrangements in which device 12 has multiple coils, the coils may be arranged in multiple layers (e.g., three layers or any other suitable number of layers) and each of the multiple layers may have coils that overlap coils in other layers.

As the AC currents pass through one or more coils 42, alternating-current electromagnetic (e.g., magnetic) fields (signals 44) are produced that are received by one or more corresponding receiver coils such as coil 48 in power receiving device 24. When the alternating-current electromagnetic fields are received by coil 48, corresponding alternating-current currents are induced in coil 48. Rectifier circuitry such as rectifier 50, which contains rectifying components such as synchronous rectification metal-oxide-semiconductor transistors arranged in a bridge network, converts received AC signals (received alternating-current signals associated with electromagnetic signals 44) from coil 48 into DC voltage signals for powering device 24.

The DC voltages produced by rectifier 50 can be used in powering an energy storage device such as battery 58 and can be used in powering other components in device 24. For example, device 24 may include input-output devices 56 such as a display, touch sensor, communications circuits, audio components, sensors, components that produce electromagnetic signals that are sensed by a touch sensor in tablet computer or other device with a touch sensor (e.g., to provide stylus (pencil) input, etc.), and other components and these components may be powered by the DC voltages produced by rectifier 50 (and/or DC voltages produced by battery 58 or other energy storage device in device 24).

Device 12 and/or device 24 may communicate wirelessly (e.g., using in-band and out-of-band communications). Device 12 may, for example, have wireless transceiver circuitry 40 that wirelessly transmits out-of-band signals to device 24 using an antenna. Wireless transceiver circuitry 40 may be used to wirelessly receive out-of-band signals from device 24 using the antenna. Device 24 may have wireless transceiver circuitry 46 that transmits out-of-band signals to device 12. Receiver circuitry in wireless transceiver 46 may use an antenna to receive out-of-band signals from device 12.

Wireless transceiver circuitry 40 can use one or more coils 42 to transmit in-band signals to wireless transceiver circuitry 46 that are received by wireless transceiver circuitry 46 using coil 48. Any suitable modulation scheme may be used to support in-band communications between device 12 and device 24. With one illustrative configuration, frequency-shift keying (FSK) is used to convey in-band data from device 12 to device 24 and amplitude-shift keying (ASK) is used to convey in-band data from device 24 to device 12. Power may be conveyed wirelessly from device 12 to device 24 during these FSK and ASK transmissions. Other types of communications (e.g., other types of in-band communications) may be used, if desired.

During wireless power transmission operations, circuitry 52 supplies AC drive signals to one or more coils 42 at a given power transmission frequency. The power transmission frequency may be, for example, a predetermined frequency of about 125 kHz, at least 80 kHz, at least 100 kHz, less than 500 kHz, less than 300 kHz, or other suitable wireless power frequency. In some configurations, the power transmission frequency may be negotiated in communications between devices 12 and 24. In other configurations, the power transmission frequency may be fixed.

During wireless power transfer operations, while power transmitting circuitry 52 is driving AC signals into one or more of coils 42 to produce signals 44 at the power transmission frequency, wireless transceiver circuitry 40 uses FSK modulation to modulate the power transmission frequency of the driving AC signals and thereby modulate the frequency of signals 44. In device 24, coil 48 is used to receive signals 44. Power receiving circuitry 54 uses the received signals on coil 48 and rectifier 50 to produce DC power. At the same time, wireless transceiver circuitry 46 uses FSK demodulation to extract the transmitted in-band data from signals 44. This approach allows FSK data (e.g., FSK data packets) to be transmitted in-band from device 12 to device 24 with coils 42 and 48 while power is simultaneously being wirelessly conveyed from device 12 to device 24 using coils 42 and 48. Other types of in-band communications between device 12 and device 24 may be used, if desired.

In-band communications between device 24 and device 12 uses ASK modulation and demodulation techniques or other suitable in-band communications techniques. Wireless transceiver circuitry 46 transmits in-band data to device 12 by using a switch (e.g., one or more transistors in transceiver 46 that are coupled coil 48) to modulate the impedance of power receiving circuitry 54 (e.g., coil 48). This, in turn, modulates the amplitude of signal 44 and the amplitude of the AC signal passing through coil(s) 42. Wireless transceiver circuitry 40 monitors the amplitude of the AC signal passing through coil(s) 42 and, using ASK demodulation, extracts the transmitted in-band data from these signals that was transmitted by wireless transceiver circuitry 46. The use of ASK communications allows a stream of ASK data bits (e.g., a series of ASK data packets) to be transmitted in-band from device 24 to device 12 with coils 48 and 42 while power is simultaneously being wirelessly conveyed from device 12 to device 24 using coils 42 and 48.

Control circuitry 16 has external object measurement circuitry 41 (sometimes referred to as foreign object detection circuitry or external object detection circuitry) that detects external objects on a charging surface associated with device 12. Circuitry 41 can detect foreign objects such as coils, paper clips, and other metallic objects and can detect the presence of wireless power receiving devices 24. During object detection and characterization operations, external object measurement circuitry 41 can be used to make measurements on coils 42 to determine whether any devices 24 are present on device 12 (e.g., whether devices 24 are suspected to be present on device 12). In capturing data from an array of coils 42, a pattern is formed, which is sometimes referred to as an impedance image or inductance image. The image may be processed by system 8 to determine which power transmission settings to use for transmitting power, etc.

In an illustrative arrangement, measurement circuitry 41 of control circuitry 16 contains signal generator circuitry (e.g., oscillator circuitry for generating AC probe signals at one or more probe frequencies, a pulse generator, etc.) and signal detection circuitry (e.g., filters, analog-to-digital converters, impulse response measurement circuits, etc.). During measurement operations, switching circuitry in device 12 may be adjusted by control circuitry 16 to switch each of coils 42 into use. As each coil 42 is selectively switched into use, control circuitry 16 uses the signal generator circuitry of signal measurement circuitry 41 to apply a probe signal to that coil while using the signal detection circuitry of signal measurement circuitry 41 to measure a corresponding response. Measurement circuitry 43 in control circuitry 30 and/or in control circuitry 16 may also be used in making current and voltage measurements, may be used in detecting impulses and other attributes in transmitted signals 44, may measure impulse responses, and/or may be used in making other measurements on wireless power receiving circuitry 54.

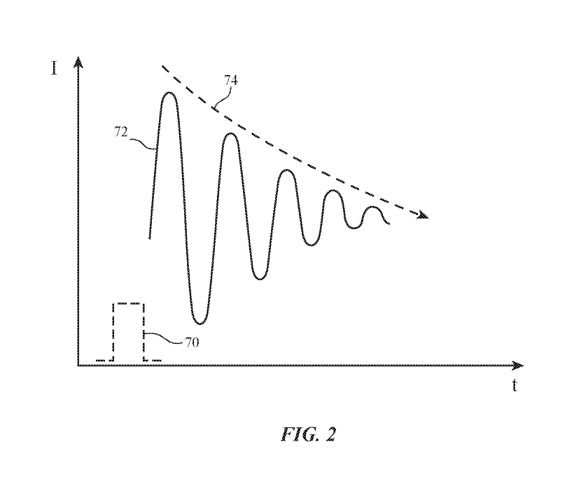

The characteristics of each coil 42 depend on whether any foreign objects overlap that coil (e.g., coins, wireless power receiving devices, etc.) and also depend on whether a wireless power receiving device with a coil such as coil 48 of FIG. 1 is present, which could increase the measured inductance of any overlapped coil 42. Signal measurement circuitry 41 is configured to apply signals to the coil and measure corresponding signal responses. For example, signal measurement circuitry 41 may apply an alternating-current probe signal while monitoring a resulting signal at a node coupled to the coil. As another example, signal measurement circuitry 41 may apply a pulse to the coil and measure a resulting impulse response (e.g., to measure coil inductance). FIG. 2 is a graph showing how power transmitting circuitry 52 may use inverter 60 to supply an impulse such as pulse 70 to an output circuit containing a coil 42. This impulse operation may cause the output circuit that contains the coil 42 to ring and decay, as illustrated by impulse response signal 72 (e.g., a signal corresponding to the resulting impulse response current flowing through coil 42 after impulse 70 is applied). Measurement circuit 41 measures the frequency of signal 72 and measures signal decay envelope 74 and extracts information on the impedance of coil 42 and other information (e.g., coil inductance, Q factor, resistance). Using measurements from measurement circuitry 41, the wireless power transmitting device can determine whether an external object is present on the coils. If, for example, all of coils 42 exhibit their expected nominal response to the applied signals, control circuitry 16 can conclude that no external devices are present. If one of coils 42 exhibits a different response (e.g., a response varying from a normal no-objects-present baseline, which is sometimes referred to as a free-space impedance), control circuitry 16 can conclude that an external object (potentially a compatible wireless power receiving device) is present.

In some situations (e.g., in an arrangement in which system 8 is operating in a low power, power-transfer-halted mode in which power is not being transferred to device 24), pulses such as pulse 70 may be generated by device 12 to measure the impedance of coil 42 (and thereby the impedance of the overlapping coil 48 of receiving device 24, which affects the impedance of coil 48 measured in device 12). Device 24 can send extremely low power in-band communications (sometimes referred to as direct-current or DC communications) to device 12 by detuning the power receiving circuit (e.g., by selectively coupling or decoupling a capacitor or other detuning circuit element into or out of the power receiving circuit). These selective DC detuning operations alter the impedance of wireless power receiving circuitry 54 in device 24 and alter impedance of the wireless power transmitting circuitry 52 of device 12, which can be detected by measurement circuitry 41.

Control circuitry 30 may have measurement circuitry 43. Measurement circuitry 43 of control circuitry 30 may contain signal generator circuitry and signal detection circuitry (e.g., filters, analog-to-digital converters, impulse response measurement circuits, etc.). During measurement operations, device 24 may use measurement circuitry 43 to make measurements to characterize device 24 and the components of device 24. For example, device 24 may use measurement circuitry 43 to measure the inductance of coil 48 (e.g., signal measurement circuitry 43 may be configured to measure signals at coil 48 while supplying coil 48 with signals at one or more frequencies to measure coil inductances, signal pulses (e.g., so that impulse response measurement circuitry in the measurement circuitry can be used to make inductance and Q factor measurements), etc. Measurement circuitry 43 may also make measurements of the output voltage of rectifier 50, the output current of rectifier 50, etc. In arrangements in which device 12 generates impulses to measure the impedance of coil 42, measurement circuitry 43 may include impulse (pulse) detection circuitry. The output of this circuitry in device 24 informs device 24 when device 12 is present (coupled to device 24) and is actively sending impulses.

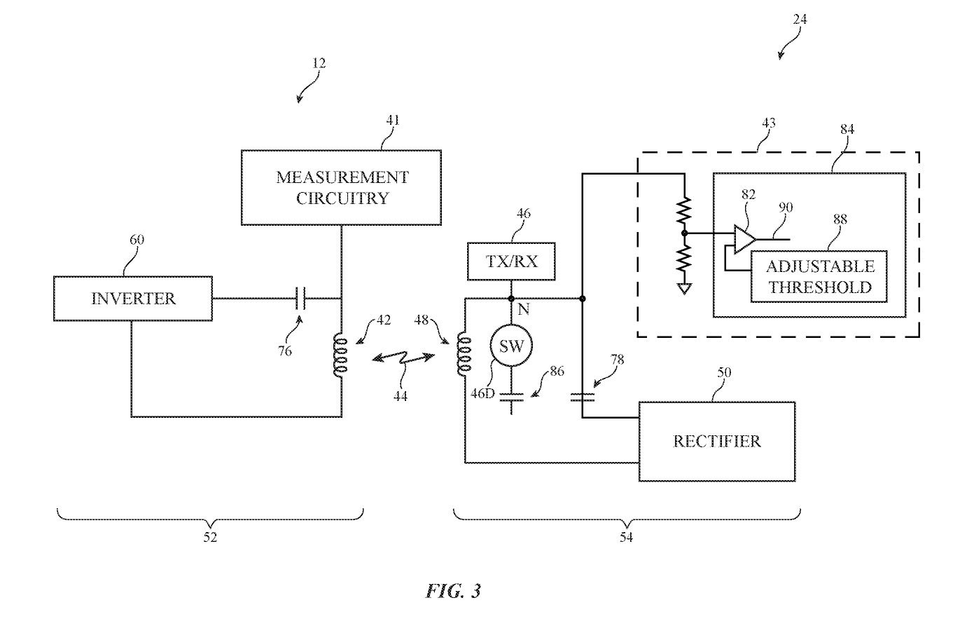

FIG. 3 is a circuit diagram of illustrative wireless power transmitting circuitry 52 in device 12 and associated illustrative wireless power receiving circuitry 54 in device 24. As shown in FIG. 3, inverter 60 may be coupled to a wireless power transmission circuit formed from coils such as illustrative coil 42 and capacitor 76 (and/or other capacitors and/or other circuit elements). During wireless power transmission operations, inverter 60 generates output signals (e.g., PWM signals) that cause electromagnetic signals 44 to be produced by coil 42. Power receiving circuitry 54 includes a coil 48 coupled to circuit components such as capacitor 78. Electromagnetic signals 44 induce a current in coil 48 that produces an alternating-current voltage that is rectified by rectifier 50.

During in-band communications, transceiver 46 may modulate the impedance of the wireless power receiving circuit (e.g., coil 48 and capacitor 78) by selectively connecting and disconnecting a capacitor or other circuit element to and from node N or other portion of the wireless power receiving circuit at a desired data rate. This type of arrangement is used to support in-band communications (e.g., ASK communications) with device 12 while device 12 is transferring wireless power signals 44 to device 24.

It is sometimes desirable to halt power transmission from device 12 to device 10. For example, if the temperature of device 24 (e.g., battery 58) exceeds a predetermined thermal limit, it may be desirable to temporarily stop transmission of power from device 12 to device 24. System 8 may then operate in a wireless-power-transfer-halted mode in which inverter 60 does not produce pulse width modulation (PWM) power output pulses and signals 44 therefore do not convey power to device 24 to charge battery 58. By stopping power transfer operations in this way, device 12 will no longer cause the temperature of battery 24 to rise.

While operating in the power-transfer-halted mode, inverter 60 does not supply PWM signals to coil 42, wireless power signals 44 are absent, and the ASK in-band transmitter of transceiver 46 does not send in-band signals to device 12 (i.e., ASK transmissions from device 24 to device 12 are interrupted). Nevertheless, device 24 is able to transmit at least one DC bit of information to device 12 (e.g., to indicate whether power transmission resumption is desired or not). This one bit of information may be conveyed to device 12 by adjusting the impedance of the wireless power receiving circuit formed from coil 48 and capacitor 78 with an impedance adjustment circuit (which may be implemented using a switch and capacitor or other circuitry in in transceiver 46 or using a separate switch and capacitor or other circuitry).

As shown in FIG. 3, an impedance adjustment circuit may be formed from a switch (e.g., switch SW) and a corresponding circuit element (e.g., capacitor 86) coupled to a node in the wireless power receiving circuit (e.g., node N). When switch SW is open, the impedance of the wireless power receiving circuit (e.g., coil 48) has a first value (e.g., Z1). When device 24 is present on device 12, this causes coil 42 and associated wireless power transmission circuitry in circuitry 52 to have an associated first value. When switch SW is closed, the impedance of the wireless power receiving circuit is changed to a second value (e.g., Z2) and the corresponding impedance of the wireless power transmitting circuitry of device 12 is changed to an associated second value. By measured the impedance of the wireless power transmission circuit (and thereby measuring the impedance of the wireless power receiving circuit), device 12 can gather information on the state of switch SW. The state of switch SW may therefore be used by device 24 to convey a desire to switch operating modes to device 12. The ability to switch between first and second impedance values therefore allows these impedance changes to be used for mode switching. Impedance state changes made with impedance adjustment circuits such as switch SW and capacitor 86 may therefore sometimes be referred to as mode switching impedance changes.

During operation, device 12 can use short measurement pulses (impulses provided with inverter 60) and measurement circuitry 41 to monitor the impulse response impedance of coil 42 (and therefore the impedance of coil 48 and its associated wireless power receiving circuitry). When device 12 detects an impedance of Z1, device 12 can conclude that device 24 is not requesting a resumption of power transfer. When device 12 detects an impedance of Z2, device 12 can conclude that device 24 is requesting a resumption of wireless power transmission operations. The state of device 24 (whether requesting a resumption of power transmission or not) can be conveyed to device 12 without simultaneously conveying power signals 44 from device 12 to device 24 and using ASK in-band communications (e.g., without using transceiver 46 to transmit an in-band data stream).

To allow device 24 to determine whether device 12 is present (e.g., to determine whether coil 48 is still overlapping coil 42), device 24 can be provided with an impulse detection circuit. In the example of FIG. 3, measurement circuit 43 has a voltage-reducing component such as voltage divider 80 that provides a reduced-magnitude signal from node N to a first input of comparator 82. Adjustable threshold circuit 88 applies an adjustable threshold value to a second input of comparator 82. Impulse detection circuitry 84 uses comparator 82 to compare the threshold from circuit 88 to the signal from voltage divider 80 and thereby sense whether an impulse is present. The threshold value supplied to the second input of comparator 82 can optionally be adjusted based on information gathered during initial in-band communications between device 24 and device 12 (e.g., to set the sensitivity of comparator 82 to a desired value for satisfactory impulse detection).

The voltage on voltage divider 80 contains impulses (pulses) corresponding to the impulses in transmitted signals from inverter 60. With one illustrative configuration, inverter 60 produces a series of short pulses whenever wireless power transmission has been temporarily halted. The impulse detection circuitry of device 24 can detect these pulses, so that device 24 is made aware that device 12 and device 24 are still coupled, even though power transmission operations have been halted.

The impulse detection circuitry in device 24 consumes a small amount of power and will therefore not significantly drain the battery of device 24. The pulses that are generated by inverter 60 in device 12 when power transmission is halted may be 4 microseconds in duration or may have other suitable short durations (e.g., at least 1 microsecond, at least 0.2 microseconds, less than 16 microseconds, less than 100 microseconds, less than 500 microseconds, etc.). The pulses may be supplied with any suitable period (e.g., a period of at least 10 ms, at least 100 ms, at least 200 ms, at least 500 ms, less than 10 s, less than 3 s, less than 1 s, less than 750 ms, etc.). The amount of energy expended in producing these impulses is negligible compared to the amount of energy expended in attempting to use transceiver circuitry 46 to send in-band data to device 12 while device 12 sends bursts (e.g., 10-30 ms bursts) of PWM power signals 44 from device 12 to device 24. While the short-duration impulses are being sent, rectifier 50 does not harvest power from these transmitted impulses and there is no wireless power transfer to device 24. The power stored in battery 58 will slowly decrease due to the power expended by circuit 42 in monitoring the impulses from device 12 and due to any power expended in other background tasks (e.g., monitoring battery temperature to determine when the battery temperature has fallen to an acceptable temperature for resumed charging, etc.). These power requirements for the halted-power-transfer mode are small, so the power-transfer-halted mode of operation may sometimes be referred to as a low-power mode or a low-power-wireless-power-transfer-halted mode.

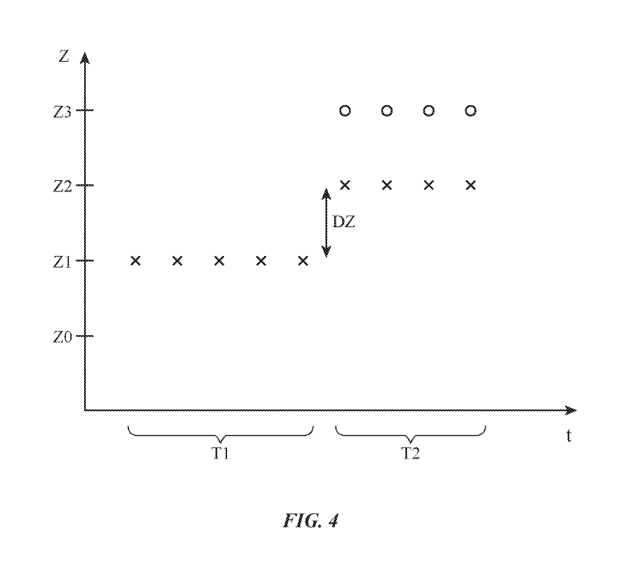

During the power-transfer-halted mode, device 12 can use measurement circuitry 41 to measure the impedance Z of coil 42 (and associated coil 48). FIG. 4 shows how impedance measurements in device 12 can vary as a function of time t. In free space (when device 24 is not present on device 12), device 12 measures a free-space impedance (e.g., impedance Z0). When device 24 is present during power-transfer-halted operations, Z may have a first value (Z1) that is influenced by the presence of the wireless power receiving circuit 54 on device 12 (see, e.g., illustrative time period T1). During time period T1, switch SW has a first state (e.g., an open state). When it is desired for device 24 to issue a mode-switching command to device 12 to direct device 12 to exit the power-transfer-halted mode, device 24 closes switch SW. This changes the impedance of the wireless power receiving circuit 54 in device 24 and thereby changes the measured impedance of coil 42 (see, e.g., changed impedance value Z2 during period T2). The change in impedance (DZ) from Z1 to Z2 is detected by measurement circuitry 41. In response, device 12 resumes wireless power transfer operations.

In an illustrative embodiment, switching circuitry (e.g., switch SW and optionally one or more additional switches) can be used to switch additional circuit components (e.g., one or more capacitors) into use (e.g., so that the impedance can be changed to one of two or more different values (e.g., from Z 1 to either Z2 or Z3, as an example). The use of optional additional switching circuits provides device 24 with the ability to send device 12 more than a single binary mode switching command during halted-power-transfer mode operations, if desired. Configurations in which device 24 uses switch SW to switch between two states (e.g., closed and open states) are illustrative.

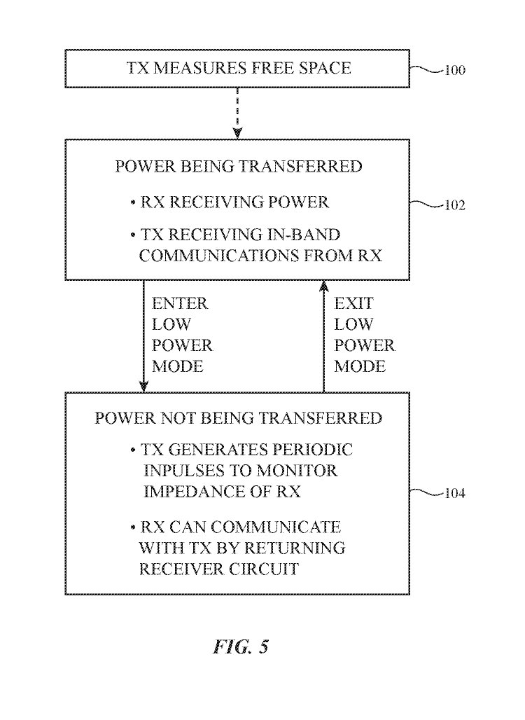

FIG. 5 is a flow chart of illustrative operations associated with using system 8 to transfer wireless power.

During the operations of block 100, device 12 can use measurement circuit 41 to measure the free-space impedance of coil(s) 42 (see, e.g., impedance Z0 of FIG. 4). The free-space impedance value may be stored in memory in device 12.

At a later time, after device 24 has been placed on device 12, system 8 may be used in wireless power transfer operations. In particular, system 8 may be operated in a first mode in which power is actively transferred between device 12 and device 24 or a second mode in which power transfer is temporarily stopped.

Wireless power may, as an example, be transmitted between device 12 and device 24 during the operations of block 102. During the operations of block 102, system 8 operates in an active power transfer mode (sometimes referred to as a power-being-transferred mode or an active wireless power transfer mode).

Wireless power transmission operations may be halted during the operations of block 104. During the operations of block 104, system 8 operates in a power-transfer-halted mode (sometimes referred to as a wireless-power-transfer-halted mode). Power transfer operations can be halted, for example, because the temperature of battery 58 has exceeded a predetermined temperature threshold value or because device 12 determines that power transmission should be halted. Once the temperature of battery 58 drops sufficiently (e.g., as measured by control circuitry 30 using a temperature sensor in devices 56) or other appropriate conditions have been satisfied, wireless power transfer operations can be resumed.

As shown in FIG. 5, power is transferred wirelessly from device 12 to device 24 during the operations of block 102. Pulse width modulation (PWM) alternating-current signals at a suitable wireless power transfer frequency (e.g., 80-300 kHz, at least 75 kHz, less than 250 kHz, etc.) are applied to coil 42 using inverter 60, thereby transferring wireless power signals 44 to power receiving circuitry 54 and rectifier 50. Rectifier 50 supplies load circuits in device 24 with corresponding direct-current power (e.g., to charge battery 58). During active power-transfer-mode operations such as these, device 12 receives in-band communications from device 24 using transceiver 40. Device 24 may, as an example, send in-band transmit-power-level adjustment commands to device 12 using transceiver 46.

If control circuitry 30 determines that power transfer operations should be halted (e.g., because a temperature sensor in device 24 indicates that battery 58 has become too hot or because other conditions have been satisfied), control circuitry 30 directs device 12 to halt wireless power transmission (e.g., by sending a halt command via in-band communications using transceiver 46 that is received by transceiver 40). Control circuitry 30 knows that device 24 is in communication with device 12, because device 24 is receiving power from device 12. Upon receiving the halt command, device 12 stops transmitting wireless power to device 24 and system 8 enters the wireless-power-transfer-halted mode (block 104). Upon transitioning to the operations of block 104 or earlier (e.g., during the operations of block 102), switch SW is opened.

During the operations of block 104, no wireless power is transferred from device 12 to device 24. Device 12 uses inverter 60 to generate a train of short impulses while using measurement circuitry 41 to measure the impulse response of coil 42 and thereby determine the impedance of coil 42 (and associated impedance of coil 48). The measured impedance is monitored by device 12 and is compared to the known free-space impedance of block 100 to confirm to device 12 that device 24 remains present during the operations of block 104. Device 24 uses impulse response measurement circuitry (FIG. 3) to monitor the impulses from device 12. The presence of incoming impulses from device 12 confirms to device 24 that device 12 is still present.

While power transfer is halted, device 24 can maintain switch SW in an open state. This causes the wireless power receiving circuit with coil 48 and therefore the wireless power transmission circuit with coil 42 to exhibit first impedance values (e.g., a first impedance (Z1), as described in connection with FIG. 4). The impedance state of the wireless power receiving circuitry in device 24 and therefore the impedance measured at coil 42 is adjusted by adjusting the state of switch SW. When device 24 desires to instruct device 12 to resume power transmission operations, device 24 closes switch SW, resulting in an impedance change in the wireless power receiving circuit and corresponding measured impedance change (e.g., impedance change DZ from Z1 to Z2) at coil 42 in device 12. The mode switching impedance change that is made by switching SW in this way is generally binary and takes place over relatively long time scales (e.g., at least multiple seconds, minutes, or more, rather than fractions of a second). Accordingly, these mode switching impedance changes are sometimes referred to as direct-current (DC) mode switching impedance changes.

In response to detection of a mode switching impedance change while operating in the power-transfer-halted mode, device 12 resumes the transfer of wireless power (e.g., inverter 60 resumes sending PWM alternating-current signals to coil 42 and rectifier 50 supplies DC output based on the received signals at coil 48). System 8 exits the power-transfer-halted mode (block 104) and enters the active-power-transfer mode (block 102).

The foregoing is merely illustrative and various modifications can be made to the described embodiments. The foregoing embodiments may be implemented individually or in any combination.

What is claimed is:

1. A wireless power receiving device operable with a wireless power transmitting device configured to transmit wireless power to the wireless power receiving device, comprising:
wireless power receiving circuitry comprising a coil, wherein the wireless power receiving circuitry is configured to receive the wireless power during operation of the wireless power receiving device in an active-power-transfer mode in which the wireless power receiving device receives wireless power from the wireless power transmitting device; and
control circuitry comprising an impulse response measurement circuit configured to measure impulses, received using the coil, from the wireless power transmitting device during operation of the wireless power receiving device in a wireless-power-transfer-halted mode.

2. The wireless power receiving device of claim 1 further comprising an impedance adjustment circuit coupled to the coil, wherein the control circuitry is configured to make a mode switching impedance change in the wireless power receiving circuitry using the impedance adjustment circuit, wherein the mode switching impedance change is configured to direct the wireless power transmitting device to switch between the wireless-power-transfer-halted mode and the active-power transfer mode.

3. The wireless power receiving device of claim 2 wherein the control circuitry is configured to make the mode switching impedance change during operation of the wireless power receiving device in the wireless-power-transfer-halted mode to direct the wireless power transmitting device to transmit the wireless power.

4. The wireless power receiving device of claim 3 further comprising an in-band communications transmitter configured to transmit amplitude shift keying data to the wireless power transmitting device while the wireless power transmitting device is transmitting the wireless power to the wireless power receiving device.

5. The wireless power receiving device of claim 3 wherein the impulse response measurement circuit has a comparator with a first input coupled to the coil and a second input.

6. The wireless power receiving device of claim 5 further comprising an adjustable threshold circuit configured to supply the second input with an adjustable threshold voltage.

7. The wireless power receiving device of claim 2 wherein the impedance adjustment circuit comprises a switch and capacitor coupled to the wireless power receiving circuitry.

8. A wireless power transmitting device configured to transmit wireless power to a wireless power receiving device having a wireless power receiving circuit with an adjustable impedance, comprising:
wireless power transmitting circuitry comprising a coil, wherein the wireless power transmitting circuitry is configured to transmit the wireless power;
measurement circuitry coupled to the coil that is configured to detect an impedance change on the coil due to a change of the adjustable impedance while transmission of the wireless power to the wireless power receiving device is halted; and
control circuitry that is configured to resume transmission of the wireless power in response to detecting the impedance change with the measurement circuitry.

9. The wireless power transmitting device of claim 8 wherein the wireless power transmitting circuitry comprises an inverter configured to provide alternating-current signals to the coil to transmit the wireless power while operating in an active-power-transfer mode.

10. The wireless power transmitting device of claim 9 wherein the control circuitry is configured to use the inverter and coil to transmit impulses to the wireless power receiving device while the transmission of the wireless power to the wireless power receiving device is temporarily halted due to a halt-power-transmission command from the wireless power receiving device.

11. The wireless power transmitting device of claim 10 wherein the control circuitry includes a receiver configured to use the coil to receive the halt-power-transmission command from the receiver while using the inverter to provide the alternating-current signals to the coil to transmit the wireless power.

12. A wireless power system operable in an active power transfer mode and a wireless-power-transfer-halted mode, comprising:
a first electronic device comprising a first coil, wherein the first electronic device is configured to:
transmit wireless power signals using the first coil during operation in the active-power-transfer mode; and
monitor an impedance of the first coil during operation in the wireless-power-transfer-halted mode; and
a second electronic device comprising a second coil and an impedance adjustment circuit, wherein the second electronic device is configured to:
receive the transmitted wireless power signals using the second coil during operation in the active-power-transfer mode; and
generate a mode-switching impedance change in the impedance by adjusting the impedance adjustment circuit during operation in the wireless-power-transfer-halted mode.

13. The wireless power system of claim 12 wherein the first electronic device comprises an inverter configured to supply alternating-current signals to the first coil to transmit the wireless power during operation in the active-power-transfer mode.

14. The wireless power system of claim 13 wherein the first electronic device comprises an in-band receiver configured to receive an in-band halt-wireless-power-transfer command from the second electronic device during operation in the active-power-transfer mode.

15. The wireless power system of claim 13 wherein the first electronic device is configured to use the inverter and the first coil to supply impulses to the second device during the wireless-power-transfer-halted mode.

16. The wireless power system of claim 15 wherein each of the impulses has a duration of less than 500 microseconds and wherein the second device comprises impulse measurement circuitry configured to detect the impulses during the wireless-power-transfer-halted mode.

17. The wireless power system of claim 12 wherein the second electronic device has a wireless power receiving circuit that includes the second coil and a capacitor coupled to the second coil and wherein the impedance adjustment circuit is coupled to the wireless power receiving circuit.

18. The wireless power system of claim 17 wherein the impedance adjustment circuit comprises a switch and a circuit component and wherein the second electronic device is configured to adjust the switch during operation in the wireless-power-transfer-halted mode to direct the first electronic device to resume transmission of the wireless power to the second electronic device.

19. The wireless power system of claim 12 wherein the first electronic device comprises a tablet computer.

20. The wireless power system of claim 19 wherein the second electronic device comprises a wireless tablet computer stylus.
